(19) United States
(12) Patent Application Publication
(10) Pub. No.: US 2004/0121729 A1
(43) Pub. Date: Jun. 24, 2004

(54) Telecommunications infrastructure linkage method and system

(76) Inventors: Chris Herndon, Alexandria, VA (US); Mike Rupar, Fairfax, VA (US)

Correspondence Address: NAVAL RESEARCH LABORATORY, ASSOCIATE COUNSEL (PATENTS), CODE 1008.2, 4555 OVERLOOK AVENUE, S.W., WASHINGTON, DC, 20375-5320, US

(21) Appl. No.: 10/691,643

(22) Filed: Oct. 24, 2003

Related U.S. Application Data
(60) Provisional application No. 60/420,680, filed on Oct. 24, 2002.

(51) Int. Cl. H04Q 7/20; H04B 7/185

(52) U.S. Cl. 455/12.1; 455/429; 455/13.1

(57) ABSTRACT

A mobile communications infrastructure platform includes a networking module that includes a plurality of inputs and outputs and a POTS line connection; a satellite module coupled to the networking module for uplinking and downlinking a satellite datastream with a communications satellite; a video module for providing a video datastream to the networking module; and a wireless telecommunications module bidirectionally coupled to the networking module for receiving telecom data from and transmitting telecom data to the networking module. The wireless telecommunications module includes a VOIP interface coupled to the networking module, a land mobile radio coupled to the VOIP interface, and a private cellular network. The mobile platform provides a bi-directional patch or link between disparate communications equipment and protocols at a site and to off-site wireless radio equipment. It also provides on-site high quality video capabilities and video streaming to off-site locations, including from an emergency site to a command center.

The present application claims the benefit of the priority filing date of provisional patent application No. 60/420,680, filed Oct. 24, 2002, and incorporated herein by reference.

### FIELD OF THE INVENTION

This invention relates to a method and system device for providing mobile emergency telecommunications and video-streaming. More particularly, the invention relates to a method and system for linking incompatible or disparate communications protocols and service providers and for providing video-streaming from a site, during an emergency or in other situations requiring the rapid establishment of a tele- and video-communications infrastructure.

### BACKGROUND ART

There are many systems directed to infrastructure deployment via satellite communications. From the first use of communications satellites in the early 1960's it was evident that these systems would provide a mechanism to provide communication assets where there were no terrestrial links. It wasn't until the graphic display of damage to our terrestrial networks on Sep. 11, 2001, that satellite communications could provide a critically needed backup for our first responders. What had only been deployed by the Military, prior to September 11^{th}, could now be used to solve many of the deficiencies that have repeatedly surfaced from agencies all across the United States.

One such system, as disclosed in U.S. patent application Ser. No. 09/774,207 filed Jan. 30, 2001 and published Aug. 1, 2002 as US 2002/0101831A1, and incorporated herein by reference, describes a system that includes a mobile auxiliary communications facility equipped with mechanisms allowing the system to link to a satellite from a desired site. A disadvantage of this system is that it continues to rely on a commercial infrastructure in order to provide communications capabilities at the deployed site. Reliance on a commercial infrastructure is disadvantageous because during emergency conditions, such as at the WTC or Pentagon on Sep. 11, 2001, the commercial infrastructure may be overloaded with users and rendered essentially useless. Another disadvantage of these systems is that emergency communications between disparate emergency service providers are not feasible or enabled, such as between fire department personnel and police personnel, who may be using incompatible wireless radio equipment operating on different frequencies. This can occur both when the emergency personnel from different municipalities respond to one or more sites involved in an emergency situation and also when those from the same municipality for whatever reason employ incompatible equipment. It may also be impractical, as at the World Trade Center on Sep. 11, 2001, to distribute on-scene compatible emergency equipment to all responders, due to the infeasibility of inventorying and supplying large quantities of radios or other wireless telecom gear and also due to the fact that many responders have already been deployed around the site.

Yet another disadvantage is that these systems provide for just telecommunications operations but do not include high quality on-scene video capabilities or a video-streaming capability from an emergency site to a command center or other locations. It can prove essential to emergency control and decision-making to provide live video-streaming from the site to remote users.

There is, therefore, a need for a mobile communications system that retains full capabilities under emergency conditions and includes the additional capabilities of enabling communications between all emergency responders and all desired sites.

### SUMMARY OF THE INVENTION

According to the invention, a mobile communications infrastructure platform includes a networking module that includes a plurality of inputs and outputs and a POTS line connection; a satellite module coupled to the networking module for uplinking and downlinking a satellite datastream with a communications satellite; a video module for providing a video datastream to the networking module; and a wireless telecommunications module bidirectionally coupled to the networking module for receiving telecom data from and transmitting telecom data to the networking module. The wireless telecommunications module includes a VOIP interface coupled to the networking module, a land mobile radio coupled to the VOIP interface, and a private cellular network.

Also according to the invention, a method of establishing the mobile infrastructure linkage system at a desired location includes transporting the platform to the location; eestablishing a satellite signal link to the platform; booting platform computers, networking modules, video modules, and wireless modules; programming the land mobile radio to a specific region or agency; commencing satellite signal acquisition; and establishing a satellite communications link between the platform and a second system node. The second system node may, for example, be another such platform or platforms, or an earth station.

The invention provides a bi-directional patch or link between disparate communications equipment and protocols at a site and to off-site wireless radio equipment.

The invention also provides on-site high quality video capabilities and video streaming to off-site locations, including from an emergency site to a command center.

The military, when deployed in other nations or theaters of operations, will use host nations infrastructure, and in many cases is critically dependant on it. The InfraLynx™ platform according to the invention provides high assurance telephony, network, and radio connectivity to remote locations, such as disaster sites and theater command posts from other remote or CONUS locations. The backbone communications path can be any combination of terrestrial wired/fiber infrastructure, military satellite, or commercial satellite assets. Telephony connectivity provides access to the PSTN (Public Switched Telephone Network), DSN (Defense Switching Network), and commercial or STU/STE phones world-wide. Network connectivity is provided allowing multiple simultaneous high assurance VPN (Virtala Private Network) connections to the Internet, NIPRNET, SIPRNET, coalition, and allied networks. The system provides local radio and cellular connections. Cellular connections are private and independent from local services but also can be automatically patched to the phone services or local radios. Local radios can be patched to other similar/dissimilar radios and phone services. Local data radio services can also be patched to each other and to the remote networks. Radio assets are dynamically tailorable to each employment, allowing interoperability with fielded systems. Radio, telephony, and network connections to the global grid and infrastructure are made using widely accepted industry standard interfaces. NSA Type I strong encryption will be employed for protection of data at rest and data in transit.

Additional features and advantages of the present invention will be set forth in, or be apparent from, the detailed description of preferred embodiments which follows.

### BRIEF DESCRIPTION OF THE DRAWINGS

FIG. 1 is a schematic diagram of a mobile infrastructure linkage system according to the invention.

FIG. 2 is a schematic diagram of a a sample network configuration with two programmable interfaces interconnecting two ATM switches according to the invention.

FIG. 3 is a schematic diagram of a wireless module with interfaces for land mobile radios and an audio distribution system according to the invention.

FIG. 4 is a schematic diagram of a VOIP interface connected to a micromatrix processor according to the invention.

FIG. 5 is a schematic diagram of a video module according to the invention.

FIG. 6 is a schematic diagram of a hub system configuration according to the invention.

FIG. 7 is a schematic diagram of a mesh system configuration according to the invention.

FIG. 8 is a block diagram of a satellite communications flow path according to the invention.

FIG. 9 is a graph showing satellite spectral usage according to the invention.

FIG. 10 is a graph showing an optimized spectrum utilization of a modified mesh system configuration according to the invention.

FIG. 11 is a graph showing an optimized spectrum utilization of a hub system configuration according to the invention.

### DETAILED DESCRIPTION OF THE PREFERRED EMBODIMENTS

Notation Used Throughout

The following notation is used throughout this document.

Term Definition

ATM Asynchronous Transfer Mode

IP Internet Protocol

LAN Local Area Network

VOIP Voice Over Internet Protocol

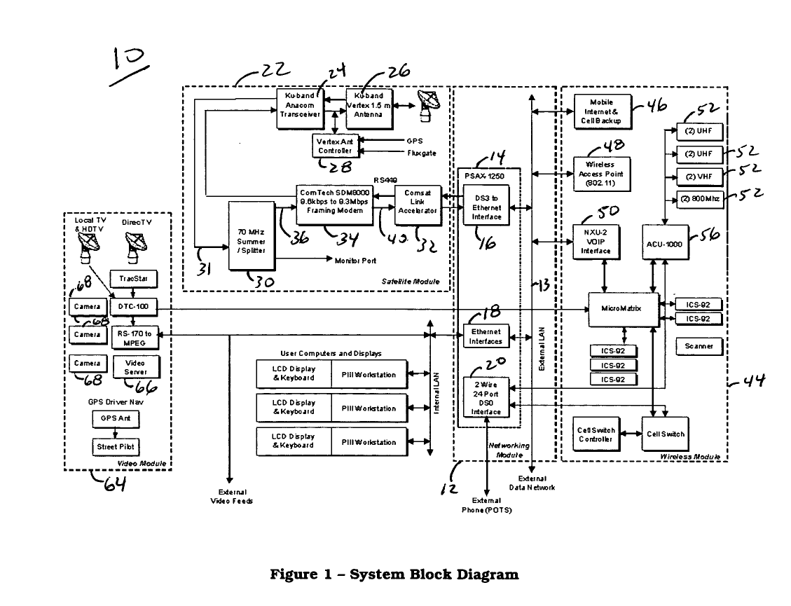

Referring now to FIG. 1, a mobile infrastructure linkage system 10, that is designed as a modular platform for installation in and/or transport on a communications van, vehicle, or trailer or the like, includes a networking module 12 for receiving and transmitting a plurality of telecommunications and other datastreams. Module 12 includes a LAN 13 and an ATM switch 14, such as the PacketStar PSAX-1250 manufactured by Lucent Technologies. Switch 14 includes both routing and multiplexing/demultiplexing capabilities, and it includes a DS3-to-internet interface 16 and Ethernet interfaces 18, each of which have bi-directional connections to the LAN 13, and a DSO interface 20. The ATM Switch 14 is also required when bulk or network encryption devices are injected into the network architecture. System 10 further includes a satellite module 22 that includes a transceiver 24, an antenna 26 with antenna/antenna controller 28, a 70 MHz summer/splitter 30 for receiving and monitoring an output signal 31 of transceiver 24, a programmable bi-directional satellite-network interface 32 coupling interface 16 with satellite module 22, and a modem 34 coupling programmable interface 32 with transceiver 24. Modem 34 has an input 36 for receiving a satellite downlink output of summer/splitter 30 and an output 40 for providing a framed RS449 serial output signal to a DS-3 input channel of programmable interface 32. Programmable interface 32, which in a preferred embodiment is an ATM link adaptation, such as the CLA-2000/ATM™ (the COMSAT link accelerator, or “CLA”), manufactured by Comsat Corp, enables inter-connection of standard ATM equipment over non-standard rate WAN links. The CLA is a networking device that enables the interconnection of Asynchronous Transfer Mode (ATM) networks over Wide Area Network (WAN) links, especially satellite and wireless links. The CLA provides efficient bandwidth utilization, improves link quality, and significantly improves the performance of applications operating over satellite and wireless ATM networks. The CLA has utility in fixed or mobile, satellite or terrestrial wireless links, and operates in a range from fractional Ti to 8.448 Mbps data rates. The CLA connects ATM switch 14 with DS3 interface 16 over a 8.448 Mbps satellite link, although the sustained rate for sending ATM cells is typically no higher than 93% of 8.448 Mbps. The CLA converts the RS449 serial output of modem 34 to be converted to DS3. This is not only a physical conversion, but also a rate conversion/buffering. The serial RS449 data to and from the modem runs at a maximum rate of 9.3 Mbps while the DS3 interface of the ATM switches run at a constant rate of 44.736 Mbps. Once converted to DS3, the signal is interfaced to networking module 12.

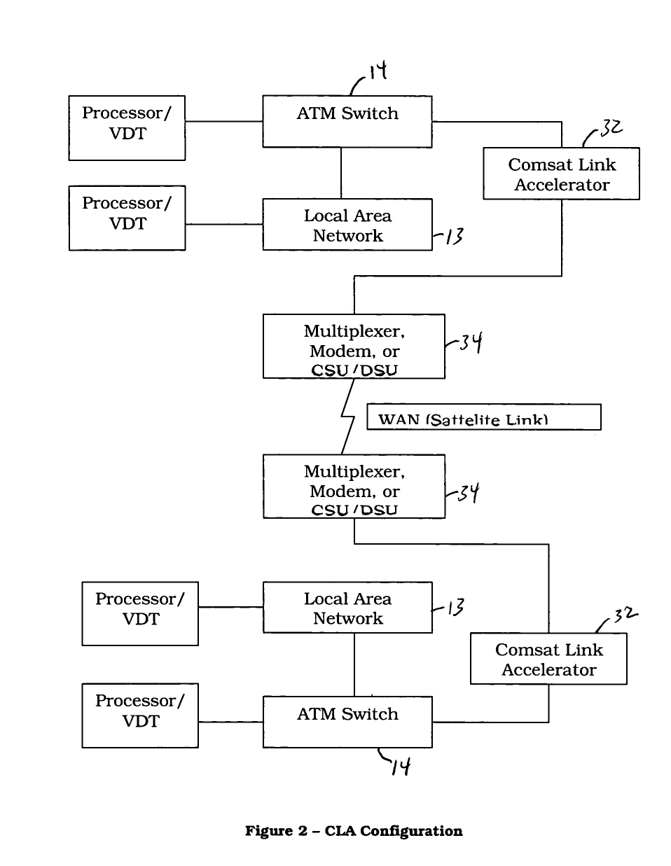

Referring also now to FIG. 2, shown is a sample network configuration with two such interfaces 32 interconnecting two ATM switches 14 over a WAN link.

As noted above, transceiver 24 includes a satellite antenna/antenna controller 28 that in a preferred embodiment is a boom-mounted antenna such as the Vertex/RSI satellite antenna system manufactured by Vertex Corp. In a preferred embodiment using this system, the up-converter is mounted on the boom of the satellite dish as opposed to the fixed side of the satellite dish. This removes the requirement of a flexible waveguide assembly for the commercial antenna, allowing a replacement with standard coaxial cable, thereby removing an expensive and high maintenance item from the configuration.

Networking module 12 is further connected to a wireless module 44 via the Local Area Network (LAN). Wireless module 44 includes a mobile internet and cellular telephone backup module 46, an 802.11 wireless access point 48, and a VOIP interface 50 each of which is bi-directionally connected to the Networking module. Internet/cell telephone module 46 integrates and includes a complete wireless cellular base station. Furthermore, whereas cellular base stations typically draw dial tone from physical connections from the public switched telephone network (PSTN), the invention also includes the creation of dial tone remotely to allow the cellular base station to function seamlessly as a “private” cellular provider exclusively for users of system 10. Many systems employ cell phones to create usable dial tone on the remote end. The integration of a complete cellular base station allows system 10 to act as the cellular service provider at an incident site, which is a commercial system manufactured by Wheat Wireless, Inc. System 10 employs the cellular base stations as AMPS, CDMA or GSM, depending on user requirements. The modular architecture allows for the quick reconfiguration from each of these types of cellular base stations. Although this is a capability that many cellular service providers employ during surge events with portable Cell-on-Wheels (COWs), wireless module 44 includes an interface that allows the cell site to act as a “private node”. This private node allows the Infralynx to provide service to only authorized individuals at an incident site. These “authorized individuals” can be programmed on the fly using their existing cell equipment or be provided a secure handset from the Infralynx equipment. Once the cellular capability has been established, the user can place calls to other users on the private cellular system. The system automatically detects the number that has been dialed and directs it to the appropriate handset. The baseline system supports 64 handsets but can easily be expanded to support additional users. The utility of this cell system is greatly expanded by terminating the cellular switch into the dial tone that is created by system 10. With eight or more POTS lines terminated into the cell switch, users then have the ability to dial out from the cell system into the Public Switched Telephone Network (PSTN). System 10 includes a dial plan that allows a cellular user on the system to direct dial other cell users, dial 3 digit extension to get any other wired user of system 10 or dial “9” to get an outside connection. An outside connection is defined as a user outside the service area of system 10. This serves as an alternative implementation to the Wireless Government Emergency Telecommunications Service (GETS).

Module 46 also includes TCP/IP connection capability while a vehicle carrying system 10 is in motion. A commercial mobile internet terminal, manufactured by KVH Corp., is integrated into system 10 to provide an operator with internet/email while in transit to an incident site. Also included is a novel backup mobile internet connection in the event that a clear view to the southern sky does not exist (urban environments). This uses one to three commercial wireless cards configured and bonded together to form a high speed connection for the users.

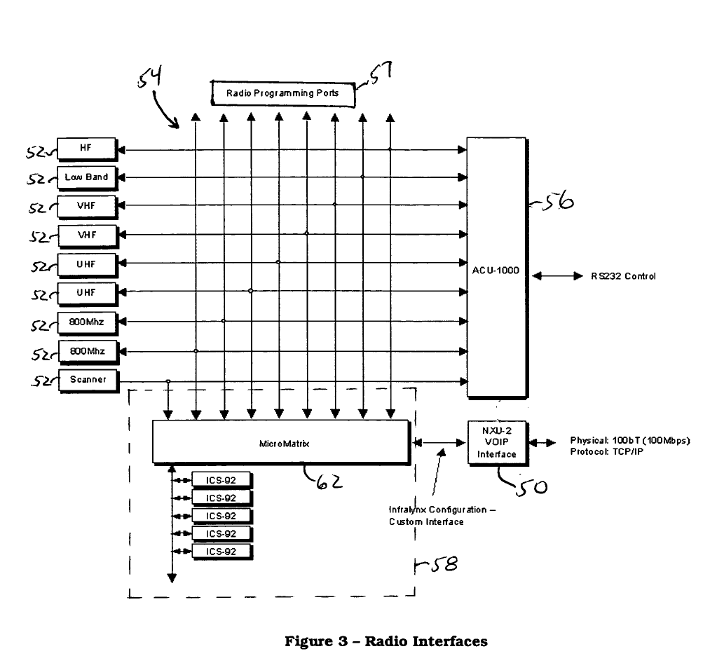

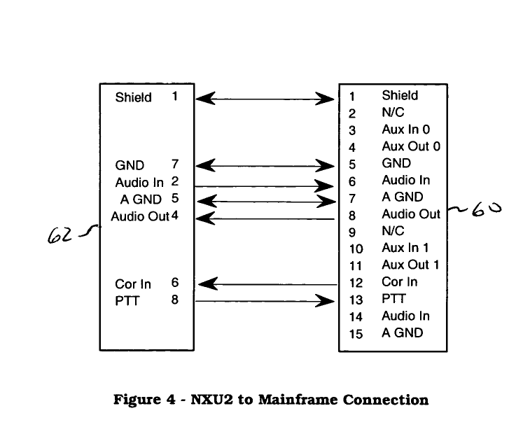

Referring also now to FIG. 3, wireless module 44 further includes land mobile radios (“LMRs”) 52 preferably covering frequencies in the range of HF (2 MHz-30 MHz), Low Band (39 MHz-54 MHz) VHF (146-174 MHz), UHF (406-450, 450-470 MHz), Public Safety (800 MHz). LMRs 52 as shown include nine off-the-shelf radios as the baseline configuration. These LMRs are discrete, single function radios that operate in the stated specific frequency bands. Each LMR 52 is equipped, from the factory, with an audio/PTT interface 54 as shown, allowing simultaneous connection to a processor 56, radio programming ports 57, and a Clear Corn audio distribution system 58. This is accomplished by modifying the manufacturers interface on the radio. The external interface must be impedance matched to maintain voice quality. Also it requires that the push-to-talk (PTT) signal is available on the rear interface. Depending on radio type, modifications are made on the internal circuit boards of the radios to change resister values to change the transmit audio impedance to allow multiple devices to be connected simultaneously and enable external PTT. This modification is available as a factory option when the radio is ordered. Processor 56 is preferably an ACU-1000, manufactured by JPS Communications, and is a key piece of the radio interoperability. The ACU-1000 allows the signal that is being received by one radio to be “translated” to other frequencies. This allows agencies with dissimilar and incompatible equipment to communicate with one another. Referring also now to FIG. 4, VOIP interface 50 connects multiple facilities together through a micromatrix processor 62 for improved dispatching ability. VOIP interface 50 in a preferred embodiment is the Network Extension Unit NXU-2 model, manufactured by JPS and designed for use with the ACU-1000. The NXU-2 converts local radio traffic to VOIP. Once in VOIP, the radio traffic is easily transported over network connections. The NXU-2 converts the analog audio to VOIP for transport. The NXU-2 consists of two main assemblies—a network processor and a digital signal processor (DSP). The network processor, a Motorola Coldfire MCF5206e, handles all the Internet Protocol (IP) related tasks, and provides an Ethernet interface to the network. The DSP, a Texas Instruments TMS320VC5409, handles all the audio-related tasks, including the voice compression and decompression. The NXU-2 can be configured as a client or a server. Servers can only accept IP connections from clients, and clients can only make and break connections from servers. Once a connection is established, however, the operation of an NXU-2 is the same regardless of whether it's a client or a server. When power is applied to an NXU-2, it either waits for a connection (if it's a server) or it attempts a connection to a server (if it's a client). The server it attempts to connect to is the one that has an IP address identical to the SRVRIP address programmed in the client. This connection is a standard TCP/IP connection on port 1221. Once a connection is established, each NXU-2 DSP begins converting analog data into digital data and compressing it to reduce the amount of bandwidth it will take to send it across the network to the associated unit. This conversion/compression process runs continuously, even if data is not currently being sent across the network. The network processor on each NXU-2 shares a common area of memory with the unit's DSP processor, allowing data to be exchanged between the two processors quickly and easily. When the network processor sees the unit's COR input line go active, it collects the frames of compressed digital audio from the DSP and packages them into packets for transmission across the network. These audio packets are sent to the NXU 2 at the other end of the link using UDP on port 1221. In addition to the audio information the packets also contain information about the status of the COR and AUX IN lines. When these packets are received at the other end of the link, the receiving network processor separates the audio from the status information and updates the unit's PTT output and AUX OUT lines based on this status information. The audio frames are then sent to the DSP for decompression. When the DSP has completed the decompression of a frame, it sends the resulting samples to the digital-to-analog (D/A) converter; the resulting analog audio signal is available at the units audio output port. This process can run in both directions simultaneously since the NXU-2 is capable of full duplex operation. Transmission of RS-232 data is handled solely by the NXU-2 network processor, and is sent using TCP on port 1221. If COR is not active the NXU-2 will send an empty packet every four seconds in order to keep the connection from timing out. The DSP master clock is the source of timing for A/D and D/A conversions as well as for transmission of packets across the network. The buffer management software in the NXU-2 can account for slight differences in master clock frequencies on each end, and can account for network jitter or packets, which arrive late.

Wireless access point 48 allows laptops and other wireless devices to connect to the data services provided by system 10.

System 10 utilizes the Clear Com audio distribution system, for example the MMX24 or the Compact 72 manufactured by Clear Com Corp. and originally developed for the television production market, and adapts it for use with LMR's 52 and other audio sources to provide users with a complete audio distribution that is run over CAT5e cable. This dramatically simplifies the installations in the field by eliminating the individual console/handset wiring for each LMR 52 and replacing it with a single CAT5e cable. This is a key attribute that allows system 10 to be setup and configured in minutes as opposed to hours using conventional wiring techniques. The radio programming kits that can be purchased with LMRs 10 allow the communication operators to change frequencies and talk groups. This is normally done in the communication facilities, not in the field. This is a contribution factor to the lack of interoperability. Many of the radio systems used today could potentially operate in frequency ranges that lie close to each other. And most of the agency radios operate on different frequencies in these close frequency ranges. If the radios can be re-programmed in the field there is a much better chance that the different agencies could communicate. System 10 integrates the radio programming kits into the configuration, so the radios can be modified on the fly. This allows system 10 to support substantially more users with less radio equipment.

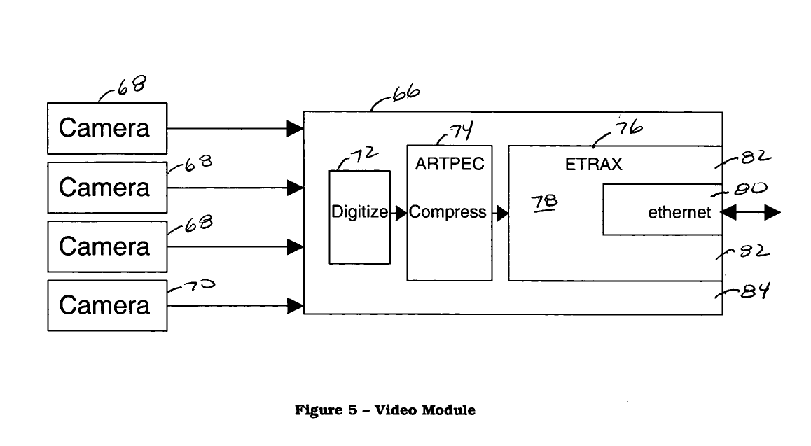

System 10 further includes a video module 64. Referring also now to FIG. 5, video module 64 includes a four channel MPEG-2 video server 66. With three cameras 68 on the perimeter of the vehicle carrying system 10 and a fourth high-powered camera 70 on a pneumatic mast (not illustrated), video server 66 streams all four camera feeds out over the internet. Video server 66 is, for example, a commercially available device such as the Axis 250 Video Server, manufactured by Axis Corp. Video server 66 receives analog video input from an analog camera 68 or 70 first into an image digitizer 72. Image digitizer 72 converts the analog video to digital format. The digital video is transferred to an encoder and compression chip 74, where the images from the video are compressed to either JPEG still images or MPEG video. The conversion to digital format and compression to JPEG images are performed by a camera controller and video compression processor 76. Processor 76, containing a CPU 78, an Ethernet connection 80, serial ports 82, and an Alarm input and relay output 84, represents the “brain” or computing functions of video server 66. It handles the communication with the network. The CPU processes the actions of the Web server and all other software (e.g. drivers for different Pan/Tilt/Zoom cameras). The Ethernet connection enables a direct network connection. The Serial ports (RS-232 and RS-485) enable control of the cameras' Pan/Tilt/Zoom function or surveillance equipment such as time-lapse recorders. A modem can also be connected. Overall, the function of video server 66 is to convert traditional CCTV signals into TCP/IP packets that can be viewed by any browser in the network (including across the satellite link). The video server also compresses the bandwidth required by each video stream to facilitate simultaneous network usage. Compression is necessary because a fully uncompressed video feed can require as much as 165 Mbps (a much larger throughput than the network or the satellite link allows). Encoding and compression is all consistent with the MPEG-2 format.

Video server 66 includes a “patch” designed and applied that allows the encoder to compensate for slow acknowledgement due to the 500 ms delay added by extending the TCP connection over satellite. Adapting the Video Server for coherent use over the satellite link requires a PC connection to be established into the server using the Telnet utility. Using scripting protocols provided in wu-ftp, standard operating protocols are modified to reflect the augmented latency. This patch is applied by telneting into the embedded operating system of the video encoder and then modifying the parameters of the commercial wu-ftp program based on the characteristics of the satellite links. Then it is reflashed to the onboard memory.

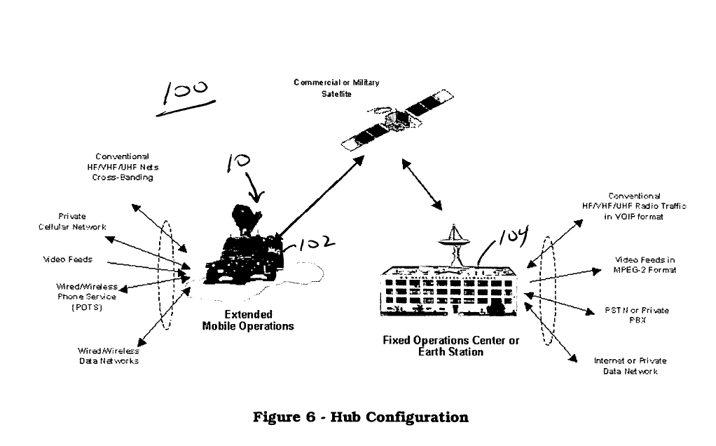

Referring now to FIG. 6, the Infralyn™ system 10 is deployed in a hub configuration 100 for a particular situation or at a desired location. System 10 arrives on scene, for example onboard a custom, integrally mounted, retrofitted vehicle 102. Vehicle 102 is preferably parked or positioned giving consideration to satellite look angles and the “dead zone” of its antenna pedestal. Stabilization jacks are deployed, and an internal generator or vehicle engine is switched over to provide power to the system. Antenna controller 28 initializes GPS and flux gate compass. The satellite system is entered by the user. Signal acquisition begins. During signal acquisition, computers and networking modules, video modules, and wireless modules are booted. LMR's 52 are programmed to the specific region or agency. Signal acquisition occurs, and the establishment of a satellite communications link between the deployed system 10 and a satellite teleport facility 104, such as the Naval Research Laboratory facility in Washington, D.C., another available government facility, or a commercial entity, is made. System 10 is then operational.

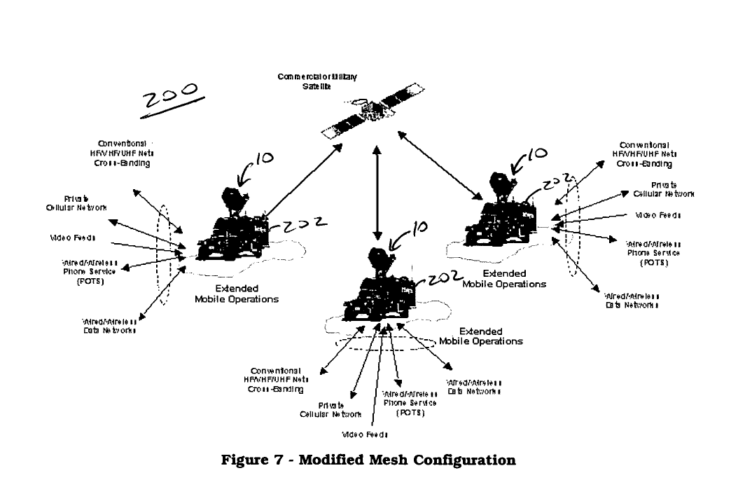

FIG. 7 illustrates a mesh configuration deployment 200 of system 10. The distinction between hub configuration 100 and mesh configuration 200 is that in the hub configuration, one node serves as the primary connection to the commercial infrastructure outside the affected area In the mesh configuration 200, each node is performing the same function with no mode connected to the commercial infrastructure, i.e. having no dependence on it. Multiple systems 10 are each mounted on a mobile platform such as a vehicle 202. Deployment in the mesh configuration is identical to that of the hub configuration. The primary difference is in the connection to the existing infrastructure. In the hub configuration, connections to the PSTN and data networks are through the earth station. In the mesh configuration, private dial tone and data networks are created between the nodes as the signals are acquired at each node. Each node in the mesh configuration acts both as the earth station and the remote node of the hub configuration. This eliminates the dependencies on the commercial service providers but still allows full communications, both data and voice, from the incident site to each of the other nodes in the network. It should be noted that “nodes” as used herein means each particular installation of a system 10 in the deployed configuration.

To accommodate this process, the satellite communications link begins with the purchase and/or use of existing satellite space segment from a satellite vendor. One of the unique aspects of system 10 is the creative use of the space segment. Segment is sold by bandwidth utilization. The way system 10 implements Asynchronous Transfer Mode (ATM) as the protocol over the satellite communication link as discussed above allows for substantially less space segment to be purchased without degradation of the performance of the network. The directional arrows in FIGS. 6 and 7 are all two-way, except for the video feeds, to indicate in each instance a bi-directional data or communications channel other than for the video feeds.

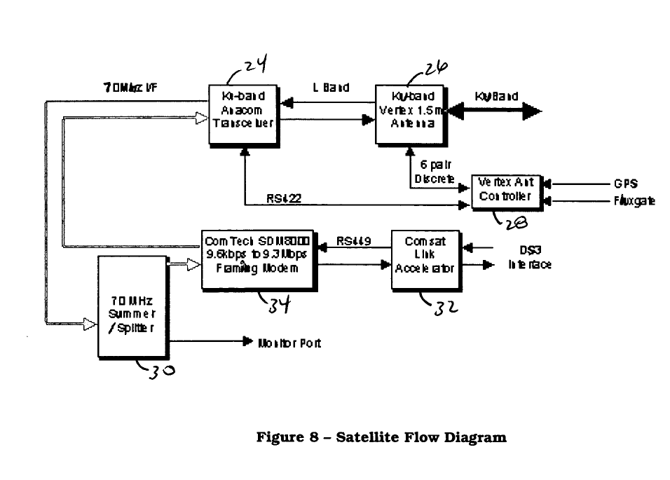

Referring also now to FIG. 8, once the satellite link has been established, a received signal is reduced from the Ku-Band spectrum to L-Band and eventually to base band (70 MHz) at the satellite modems. More particularly, the satellite signal is received by the Low Noise Block down-converter (LNC) and stepped down to L-Band (500 MHz-1500 MHz). The signal then enters the transceiver 24 where it is block down converted again to 70 MHz base band. One such appropriate transceiver is made by Anacom, providing programmable adaptation for use throughout the world (where other frequency conventions may apply) with a corresponding LNC, as well as an RS-232 monitor and control port for remote operation. The transceiver allows the signal to be interfaced directly to the commercial satellite modem 34 at the Receive I/F connection of the modem. The transmit path is the reverse. From the Transmit I/F connection of the modem, the signal leaves as 70 MHz, and subsequently out of the up-converter at Ku Band into the High Power Amplifier (HPA) (not illustrated) for transmission. The satellite modems 34 then convert the signal to RS449 (serial) data to the serial-to-DX-3 converter/accelerator 32 and finally to the DS3 interface of the ATM Switch as discussed above. At this point the satellite link can effectively be multiplexed/de-multiplexed by the next functional module into native formats of telephone lines (POTS), TCP/IP network traffic and video/audio. Once in the native format, the uses are virtually endless. System 10 becomes a complete, remote extension of the data and network services that can support many different applications.

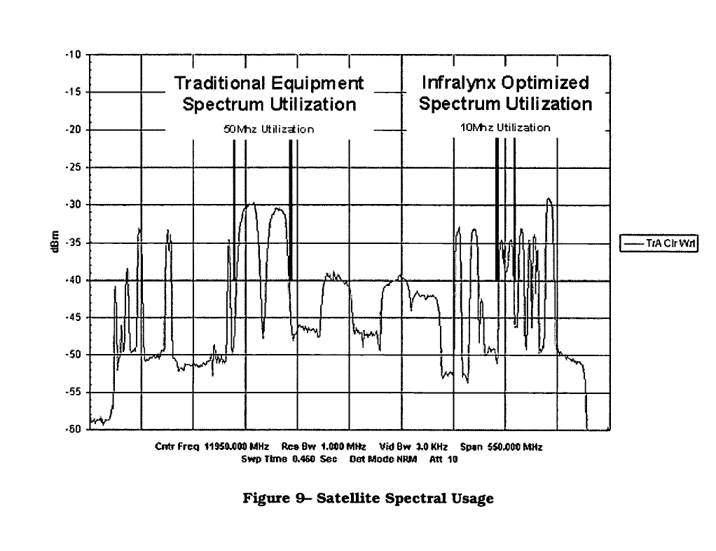

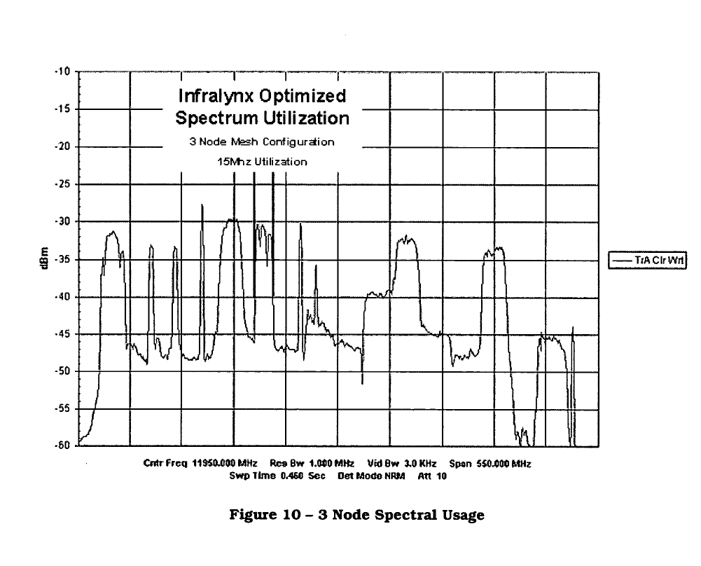

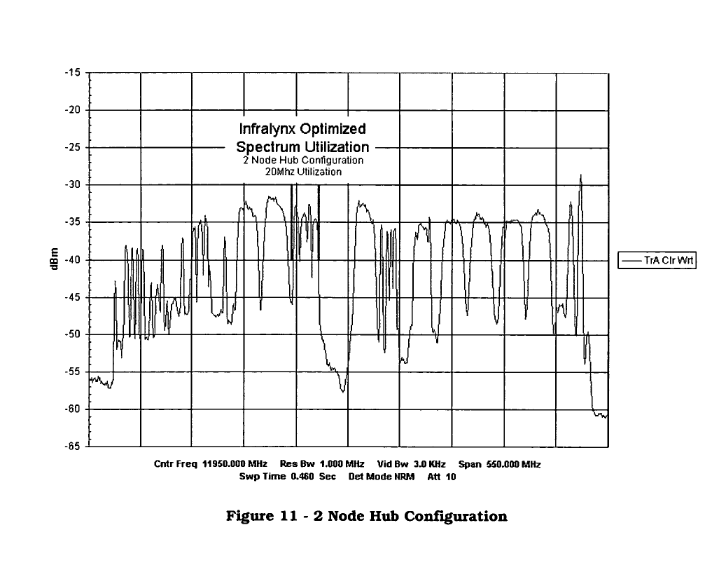

FIG. 9 is a graph comparing the utilization by system 10 (“Infralynx”) to traditional equipment. The optimization of the bandwidth allows the same network performance to be achieved using only 10 MHz of bandwidth as opposed to the conventional approach which requires 50 MHz of bandwidth. Advanced encoding techniques, forward error correction and compression implemented in the satellite data modem are key to achieving the space segment performance shown therein. FIG. 10 is a graph showing the spectrum utilization of a system 10 in the modified “mesh” configuration of FIG. 6. This is a point-to-multi-point configuration that allows services to be distributed to multiple sites. This configuration supports distributed services to multiple locations without needing additional satellite bandwidth. As shown, three Infralynx systems are working as a modified “mesh” configuration. This configuration supports the point-to-multi-point configuration that allows multiple nodes to work without a network management “hub”. FIG. 11 is a spectrum plot of two Infralynx systems deployed in the “hub” configuration shown in FIG. 7. The two larger carriers between the lines are from the hub site, which for experimental purposes was the NRL uplink at Bldg 1. Use of a hub configuration will allow for higher bandwidths to be moved to and from each individual Infralynx node compared to the mesh configuration. The hub is required to have one modem for each Infralynx node that is communicating with, and the individual nodes can communicate with each other via the network. The two smaller carriers are the uplinks, or transmit carriers from each of the two Infralynx systems. This configuration requires additional space segment bandwidth, but provides two independent links from the hub to each site. The effective bandwidth does not appear to the users to be “shared” as it does in the mesh configuration. FIG. 12 shows tests that have been performed to measure the full capacity of a representative system 10. The spectrum represents the space segment utilization that's supports simultaneous connections of 96 voice/data calls, 10 Mbps NIPR and 4 Mbps SIPR.

Other modules can be incorporated into system 10 as desired for a particular configuration or application. For example, system 10 may optionally include a standard FAA air traffic control pattern module and VDT in order to track the status of all commercial air traffic over the US at any time. This has obvious relevance and utility in a Nov. 11, 2001-type scenario.

Obviously many modifications and variations of the present invention are possible in the light of the above teachings. It is therefore to be understood that the scope of the invention should be determined by referring to the following appended claims.

We claim:

1. A mobile communications infrastructure platform, comprising:
a networking module including a plurality of inputs and outputs and including a POTS line connection;
a satellite module coupled to said networking module for uplinking and downlinking a satellite datastream with a communications satellite;
a video module for providing a video datastream to said networking module; and
a wireless telecommunications module bidirectionally coupled to said networking module for receiving telecom data from and transmitting telecom data to said networking module, said wireless telecommunications module including:
a VOIP interface coupled to said networking module;
a land mobile radio coupled to said VOIP interface; and
a private cellular network for providing private wireless cellular service independent of commercial cellular providers.

2. A mobile communications infrastructure platform as in claim 1, wherein a second node provides dial tone via satellite to telephonic equipment at a site of deployment of the platform.

3. A mobile communications infrastructure platform as in claim 1, wherein the private cellular network is a cellular base station supporting Advanced Mobile Phone Service (AMPS) protocol or Code-Division Multiple Access (CDMA) protocol.

4. A mobile communications infrastructure platform as in claim 1, wherein the wireless module includes a VOIP router and a conversion/deconversion mechanism for providing voice, audio, and/or speech signals to the VOIP router.

5. A mobile communications infrascture platform as in claim 1, wherein the wireless module includes networking module includes an ATM switch for multiplexing, demultiplexing and allocating bandwidth to combine voice and data packets into a single composite data channel.

6. A mobile communications infrastructure platform as in claim 5, wherein the ATM switch provides a wired or a wireless LAN with encryption.

7. A mobile communications infrastructure platform as in claim 1, wherein the networking module includes:
a DSO interface for connecting to a telephonic PSTN (Public Switched Telephone Network) network; and
a LAN connected to a data network that includes at least one of the internet, a proprietary corporate network, or a governmental communications network.

8. A mobile communications infrastructure platform as in claim 1, wherein the networking module accepts a variety of commercial and private telephony services and converts them both in signal type, conditioning and protocol for distribution to and from the platform.

9. A mobile communications infrastructure platform as in claim 1, wherein the networking module accepts DSO, DS 1, T1 and PRI and converts to FXS (foreign exchange station). Telephony distribution system that accepts FXO (foreign exchange office) analog dial tone and converts to DSO, DS1, T1 and PRI.

10. A mobile communications infrastructure platform as in claim 1, wherein the platform provides telephonic and data communication networks without relying on regional landline communication links.

11. A mobile communications infrastructure platform as in claim 1, further comprising an earth station.

12. A mobile communications infrastructure platform as in claim 1, further comprising an analog switch coupling said VOIP interface to a micromatrix and said land mobile radio.

13. A mobile communications infrastructure platform as in claim 1, wherein said infrastructure platform is installed in a vehicle.

14. A mobile communications infrastructure platform as in claim 1, further comprising compatible methods and equipment for accelerating throughput for standard protocols through satellite channels or any other channel with a high latency.

15. A mobile communications infrastructure platform as in claim 1, wherein the wireless module provides multiple cross-bands wirelessly over an encrypted wireless link such that a first land mobile radio operating on a first frequency or hopset is linked via the platform to a second land mobile radio operating on a second frequency or hopset, thereby enabling communications between the first and second land mobile radios.

16. A mobile infrastructure linkage system, comprising:
an earth station;
a networking module including a plurality of inputs and outputs and including a POTS line connection;
a satellite module coupled to said networking module for uplinking and downlinking a satellite datastream with a communications satellite;
a video module for providing a video datastream to said networking module; and
a wireless telecommunications module bidirectionally coupled to said networking module for receiving telecom data from and transmitting telecom data to said networking module, said wireless telecommunications module including:
a VOIP interface coupled to said networking module;
a land mobile radio coupled to said VOIP interface; and
a private cellular network.

17. A mobile infrastructure linkage system as in claim 16, wherein a second node provides dial tone via satellite to telephonic equipment at a site of deployment of the platform.

18. A mobile infrastructure linkage system as in claim 16, wherein the private cellular network is a cellular base station supporting Advanced Mobile Phone Service (AMPS) protocol or Code-Division Multiple Access (CDMA) protocol.

19. A mobile infrastructure linkage system as in claim 16, wherein the wireless module includes a VOIP router and a conversion/deconversion mechanism for providing voice, audio, and/or speech signals to the VOIP router.

20. A mobile infrastructure linkage system as in claim 16, wherein the wireless module includes networking module includes an ATM switch for multiplexing, demultiplexing and allocating bandwidth to combine voice and data packets into a single composite data channel.

21. A mobile infrastructure linkage system as in claim 20, wherein the ATM switch provides a wired or a wireless LAN with encryption.

22. A mobile infrastructure linkage system as in claim 16, wherein the networking module includes:
a DSO interface for connecting to a telephonic PSTN (Public Switched Telephone Network) network; and
a LAN connected to a data network that includes at least one of the internet, a proprietary corporate network, or a governmental communications network.

23. A mobile infrastructure linkage system as in claim 16, wherein the networking module accepts a variety of commercial and private telephony services and converts them both in signal type, conditioning and protocol for distribution to and from the platform.

24. A mobile infrastructure linkage system as in claim 16, wherein the networking module accepts DSO, DS 1, T1 and PRI and converts to FXS (foreign exchange station) Telephony distribution system that accepts FXO (foreign exchange office) analog dial tone and converts to DSO, DS1, T1 and PRI.

25. A mobile infrastructure linkage system as in claim 16, wherein the platform provides telephonic and data communication networks without relying on regional landline communication links.

26. A mobile infrastructure linkage system as in claim 16, further comprising an analog switch coupling said VOIP interface to a micromatrix and said land mobile radio.

27. A mobile infrastructure linkage system as in claim 16, wherein said system is a mesh configuration.

28. A mobile infrastructure linkage system as in claim 16, wherein said system is a hub configuration.

29. A mobile infrastructure linkage system as in claim 16, further comprising compatible methods and equipment for accelerating throughput for standard protocols through satellite channels or any other channel with a high latency.

30. A method of establishing a mobile infrastructure linkage system at a desired location, comprising:
providing a mobile communications infrastructure platform comprising:
a networking module including a plurality of inputs and outputs and including a POTS line connection;
a satellite module coupled to said networking module for uplinking and downlinking a satellite datastream with a communications satellite;
a video module for providing a video datastream to said networking module; and
a wireless telecommunications module bidirectionally coupled to said networking module for receiving telecom data from and transmitting telecom data to said networking module, said wireless telecommunications module including:
a VOIP interface coupled to said networking module;
a land mobile radio coupled to said VOIP interface; and
a private cellular network;
establishing a satellite signal link to said platform;
booting platform computers, networking modules, video modules, and wireless modules;
programming the land mobile radio to a specific region or agency;
commencing satellite signal acquisition; and
establishing a satellite communications link between the platform and a second system node.

31. A method as in claim 30, wherein the second system node is a second said mobile communications infrastructure platform.

32. A method as in claim 30, wherein the second system node is an earth station.

33. A method as in claim 30, wherein the platform is positioned on a vehicle, and wherein the method further comprises:
positioning the vehicle to optimize satellite look angles and minimize a dead zone of an antenna pedestal;
deploying vehicle stabilization jacks;
providing an on-site-generated power source for the platform; and
providing an antenna controller for initializing GPS and a flux gate compass.

34. A method as in claim 30, futhrer comprising providing dial tone via satellite to telephonic equipment at a site of deployment of the platform.

35. A method as in claim 30, further comprising multiplexing, demultiplexing and allocating bandwidth to combine voice and data packets into a single composite data channel.

36. A method as in claim 30, further comprising providing a wired or a wireless LAN with encryption.

37. A method as in claim 30, wherein telephonic and data communication networks are provided without relying on regional landline communication links.

38. A method as in claim 30, further comprising providing compatible methods and equipment for accelerating throughput for standard protocols through satellite channels or any other channel with a high latency.
